(19) United States
(12) Patent Application Publication
(10) Pub. No.: US 2009/0295749 A1
(43) Pub. Date: Dec. 3, 2009

(54) COMMODITY INFORMATION DISPLAY APPARATUS

(75) Inventors: Hisashi Sato, Shizuoka (JP); Yoshihiko Ikeda, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/472,451

(22) Filed: May 27, 2009

(30) Foreign Application Priority Data
May 28, 2008 (JP) 2008-139944

(51) Int. Cl. G06F 3/041; G09G 5/00

(52) U.S. Cl. 345/173; 345/156

(57) ABSTRACT

A display or a display terminal includes a display panel. The display panel displays commodity information of commodities displayed in a store. A touch panel is stacked and arranged on a display surface of the display panel. An RFID reader reads administrator information stored in an authentication card. When a microcomputer determines that the administrator information is read, the microcomputer changes a mode of the display or the display terminal from a normal mode to a changing mode. In the normal mode, display content of the display panel is not changed even if the touch panel is touched and designated. In the changing mode, the display content of the display panel is switched according to the touch and designation on the touch panel. When the touch panel is touched and designated under the changing mode, the microcomputer switches display content of a display area corresponding to a touched and designated coordinate between normal display for displaying only the commodity information and special display for displaying sold-out information together with the commodity information.

### CROSS REFERENCE TO RELATED APPLICATION

The present application is based on and claims the benefit of priority of Japanese Patent Application No. 2008-139944 filed on May 28, 2008, the entire contents of which is incorporated herein by reference.

### TECHNICAL FIELD

The present invention relates to a commodity information display apparatus that is installed in various sales stores and displays commodity information concerning commodities for sale.

### BACKGROUND

An electronic price tag display terminal is attached to a commodity showcase.

JP-A-7-77940 discloses an electronic price tag display apparatus. The electronic price tag display apparatus includes an operation unit such as keys in the front thereof. The electronic price tag display apparatus switches a display message according to operation from the operation unit. When a display terminal includes an operation unit for quickly changing display content like the electronic price tag display apparatus, not only store clerks but also various people including customers can change display content displayed on a display unit of the display terminal. In this case, it is likely that the display content on the display unit is switched without permission because of pranks unexpected by the store clerks and the display unit does not properly display states of commodities displayed in a commodity showcase.

### SUMMARY

It is an object of the present invention to allow only predetermined people such as store clerks to quickly change display of commodity information.

According to an aspect of the present invention, a commodity information display apparatus is provided which includes: a display unit that displays commodity information; an input unit for performing operation input; an authenticating unit that authenticates authority for changing display content of the display unit; and an information processing unit that executes (i) mode changing processing for setting, only when success of the authentication in the authenticating unit is determined, a mode in a changing mode for permitting a change of the display content displayed on the display unit and (ii) display changing processing for controlling, in a state in which the mode is set in the changing mode, the display unit according to the operation input from the input unit and performing, on the display unit, any one of normal display for displaying only the commodity information and special display for displaying the commodity information and special information.

According to another aspect of the present invention, a display switching method is provided which includes: determining whether authentication of authority for changing display content of a display unit, which displays commodity information, is successful; setting, when the authentication is successful, a mode in a changing mode for permitting a change of the display content displayed on the display unit; and performing, on the display unit, in a state in which the mode is set in the changing mode, according to operation input from an input unit for performing the operation input, any one of normal display for displaying only the commodity information and special display for displaying the commodity information and special information.

### DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is an external perspective view of an entire commodity information display apparatus according to an embodiment;

FIGS. 2A to 2D are diagrams for explaining a procedure of operation for switching display content of a display panel;

FIG. 3 is a block diagram of an electric configuration of the commodity information display apparatus;

FIG. 4 is a flowchart of a flow of mode switching processing;

FIG. 5 is a flowchart of a flow of display switching processing;

FIG. 6 is a flowchart of a flow of display switching processing; and

FIGS. 7A to 7I are diagrams for explaining a procedure of operation for switching display content of a display.

### DETAILED DESCRIPTION

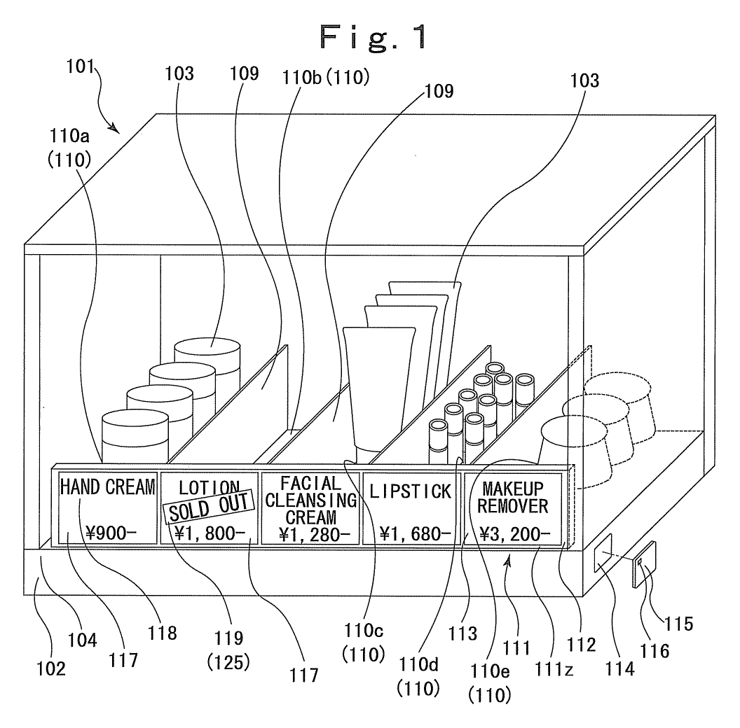

An embodiment is explained with reference to FIGS. 1 to 5. A commodity information display apparatus 101 according to this embodiment includes a display 111. The display 111 includes an elongated display unit that can display plural kinds of commodity information. A touch panel is stacked and arranged on the display unit. When the touch panel is touched and designated, the display 111 changes commodity information corresponding to a touched and designated coordinate among the commodity information displayed on the display unit.

FIG. 1 is an external perspective view of the entire commodity information display apparatus 101. A commodity showcase 102 is set in a commodity selling floor of a store. Plural kinds of commodities 103 are placed on a display counter 104.

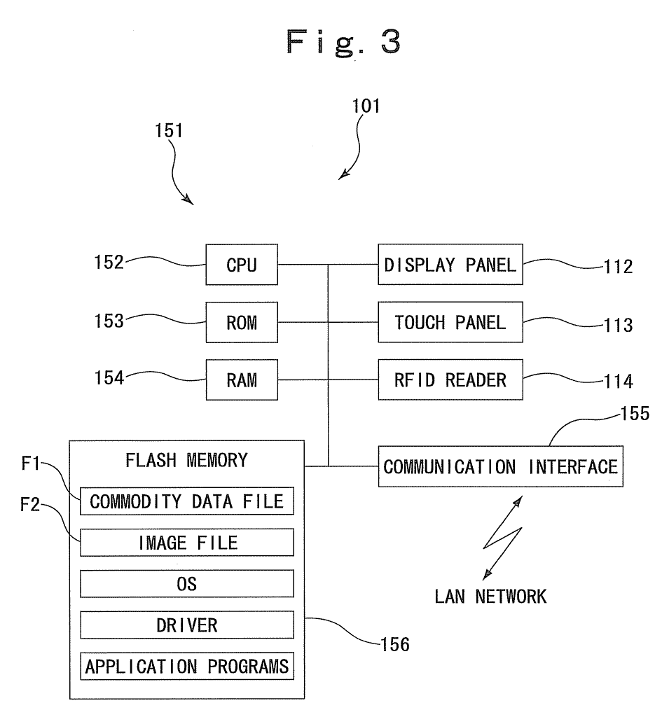

The display 111 is vertically provided on an upper surface of the display counter 104. A display surface 111z of the display 111 faces the front. An RFID reader 114 is attached to a right side of the display counter 104. The display counter 104 houses a microcomputer 151 (see FIG. 3) serving as an information processing unit in the inside thereof. The display 111, the RFID reader 114, and the microcomputer 151 configure the commodity information display apparatus 101.

Four partition plates 109 are arranged behind the display 111 and on the upper surface of the display counter 104. The display counter 104 includes five commodity placing rows 110 on the upper surface.

The display 111 includes a long rectangular display panel 112 of a liquid crystal display system. A touch panel 113 that plays a role as an input unit is stacked and arranged on the display surface 111z of the display panel 112. The display surface 111z includes five display areas 117 set in advance. The five display areas 117 are present in positions corresponding to the commodity placing rows 110. The display areas 117 display commodity information 118. The commodity information 118 indicates commodity names, sales prices, and the like.

In FIG. 1, the display areas 117 display commodity names and sales prices as the commodity information 118. These kind of commodity information 118 correspond to first to fifth commodity placing rows 110a to 110e, respectively. The display areas 117 display special information 125 concerning the commodities 103. The special information 125 is images of the commodities 103 displayed in the commodity showcase 102 and sold-out information 119. The sold-out information 119 is, for example, an image having a text “sold out”. The microcomputer 151 (see FIG. 3) displays the sold-out information 119 on a front surface of an area in a part of the commodity information 118.

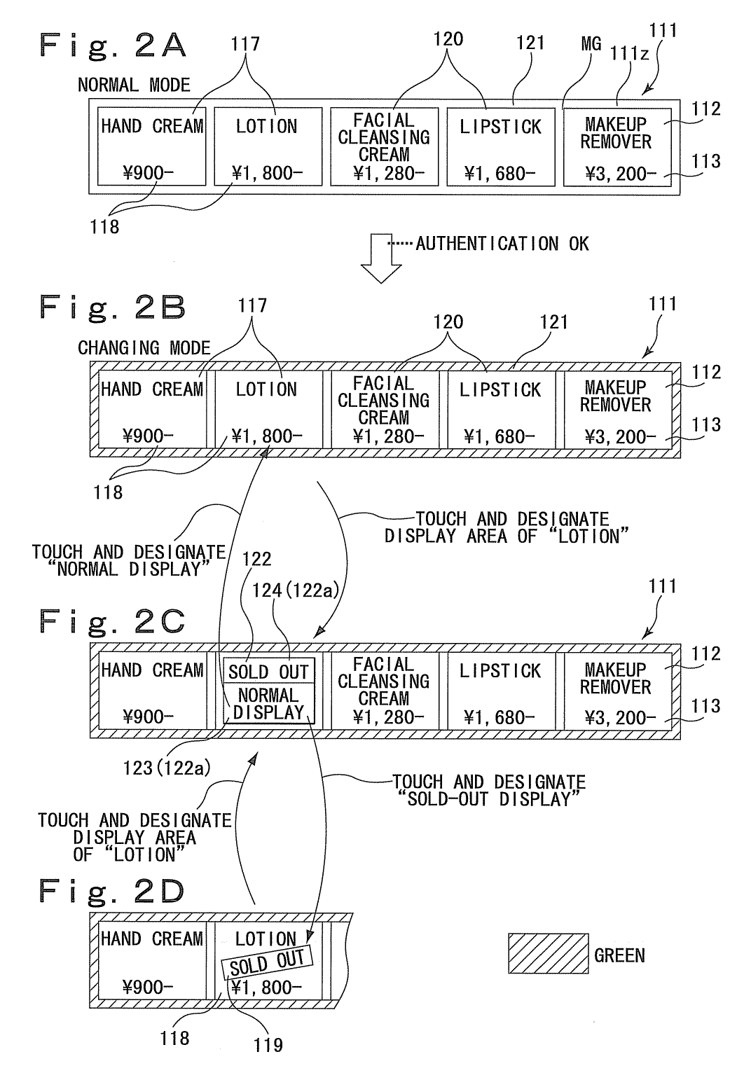

A store clerk carries an authentication card 115 embedded with an RFID tag 116. The RFID reader 114 executes RFID communication with the RFID tag 116 in the authentication card 115. The RFID reader 114 reads administrator information stored in the RFID tag 116. The RFID reader 114 inputs the read administrator information to the microcomputer 151. When the microcomputer 151 determines that the administrator information is input, the microcomputer 151 authenticates authority for changing display content of the display panel 112. The microcomputer 151 changes a mode of the display 111 from a normal mode to a changing mode. The RFID reader 114 plays a role as an authenticating unit. The normal mode and the changing mode are explained with reference to FIGS. 2A to 2D.

FIGS. 2A to 2D are diagrams for explaining a procedure of operation for switching display content of the display 111. The display surface 111z has rectangular ruled lines 120 for specifying the display areas 117. An area further on an outer side than the rectangular ruled lines 120 in the display areas 117 plays a role as a mode display section 121 indicating the mode of the display 111. When the mode is the changing mode, the mode display section 121 indicates green (FIGS. 2B to 2D). When the mode is the normal mode, the mode display section 121 indicates white (FIG. 2A). The changing mode is a mode in a state in which the display panel 112 changes display content according to touch and designation on the touch panel 113. The normal mode is a mode in a state in which the display panel 112 does not change display content even if the touch panel 113 is touched and designated.

FIG. 2A is a diagram of a display example of the normal mode. FIG. 2B is a diagram of a display example of the changing mode. FIG. 2C is a diagram of a display example of a popup menu 122 displayed, when the display area 117 in the changing mode is touched and designated, on the display area 117. The popup menu 122 is a menu for an operator to select and determine display content. The popup menu 122 includes plural menu buttons 122a as menu items. The menu buttons 122a include a normal display button 123 and a sold-out information display button 124. The normal display button 123 is a button image for causing the display area 117 to display only the commodity information 118. The sold-out information display button 124 is a button image for causing the display area 117 to display the sold-out information 119 together with the commodity information 118.

FIG. 2D is a diagram of a display example of special display performed on the display area 117 when the sold-out information display button 124 is touched and designated. The special display is display for displaying the sold-out information 119 together with the commodity information 118.

FIG. 3 is a block diagram of an electric configuration of the commodity information display apparatus 101. The commodity information display apparatus 101 includes the microcomputer 151 serving as an information processing unit. The microcomputer 151 includes a CPU 152, a ROM 153, and a RAM 154. The microcomputer 151 is connected to the display panel 112, the touch panel 113, the RFID reader 114, and a communication interface 155 via various input and output circuits (not shown in the figure) and controls to drive these units. The communication interface 155 realizes data communication between the microcomputer 151 and other information processing apparatuses connected to a LAN network disposed in the store.

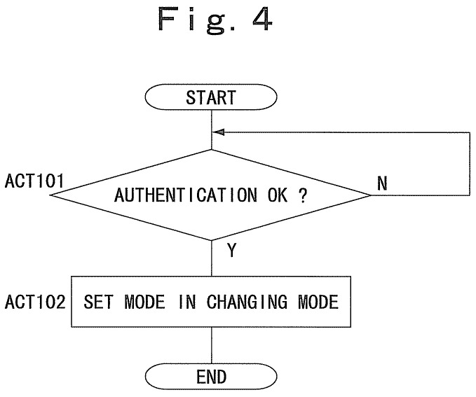

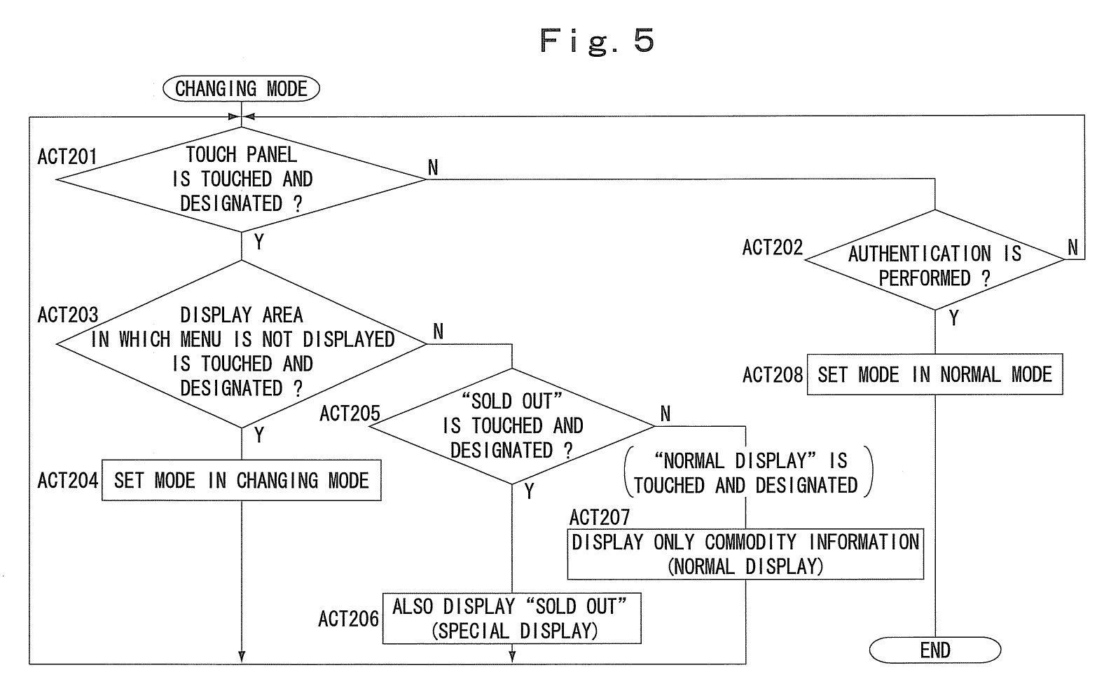

The microcomputer 151 is connected to a flash memory 156. The flash memory 156 stores a commodity data file F1 and an image file F2. The commodity data file F1 stores commodity information such as commodity names and commodity unit prices in association with commodity codes. The image file F2 stores the sold-out information 119 and various images such as images of the normal display button 123 and the sold-out information display button 124 configuring the popup menu 122. Further, the flash memory 156 stores various programs such as an OS, a driver, and application programs. The application programs include description of processing contents of mode switching processing (see FIG. 4) and display switching processing (see FIG. 5) executed by the microcomputer 151.

FIG. 4 is a flowchart of a flow of the mode switching processing. The microcomputer 151 stands by for the RFID reader 114 to read administrator information stored in the RFID tag 116 of the authentication card 115 (Act 101). When the microcomputer 151 determines that the RFID reader 114 reads the administrator information (Y in Act 101), the microcomputer 151 changes the mode of the display 111 from the normal mode to the changing mode (Act 102). In Act 102, the microcomputer 151 also controls the display panel 112 to change the display of the mode display unit 121 from white to green. Following the processing in Act 102, the microcomputer 151 performs the display switching processing explained below.

FIG. 5 is a flowchart of a flow of the display switching processing. Under the changing mode, the microcomputer 151 stands by for any one of touch and designation on the touch panel 113 and reading of the administrator information by the RFID reader 114 (Act 201 and Act 202).

When the microcomputer 151 determines that the touch panel 113 is touched and designated (Y in Act 201), the microcomputer 151 executes processing corresponding to the display of the display panel 112 corresponding to a touched and designated coordinate. When the microcomputer 151 determines that the display area 117 on which the popup menu 122 is not displayed is touched and designated (Y in Act 203), the microcomputer 151 displays the popup menu 122 (see FIG. 2C) on the display area 117 (Act 204) and returns the processing to Act 201. On the other hand, when the microcomputer 151 determines that the sold-out information display button 124 in the displayed popup menu 122 is touched and designated (N in Act 203 and Y in Act 205), the microcomputer 151 erases the popup menu 122 displayed on the display area 117 corresponding to a touched and designated coordinate, displays the sold-out information 119 on the display area 117 together with the commodity information 118 (Act 206), and returns the processing to Act 201. Further, when the microcomputer 151 determines that the normal display button 123 in the displayed popup menu 122 is touched and designated (N in Act 203 and N in Act 205), the microcomputer 151 erases the popup menu 122 displayed on the display area 117 corresponding to a touched and designated coordinate, displays only the commodity information 118 on the display area 117 (Act 207), and returns the processing to Act 201.

On the other hand, in Act 201 and Act 202, when the microcomputer 151 determines that the RFID reader 114 reads the administrator information (N in Act 201 and Y in Act 202), the microcomputer 151 changes the mode of the display 111 from the changing mode to the normal mode (Act 208). In Act 208, the microcomputer 151 also controls the display panel 112 and changes the display of the mode display unit 121 from green to white.

After the execution of Act 208, the microcomputer 151 performs the mode switching processing (see FIG. 4).

An example of operation for changing display content of the display 111 is explained below. When the store clerk recognizes that the commodities 103 displayed in certain one row among the commodity placing rows 110a to 110e are sold out, in order to change the mode of the display 111 from the normal mode to the changing mode, the store clerk holds the authentication card 115 over the RFID reader 114. After confirming that the mode of the display 111 is the changing mode because the mode display unit 121 displays green, the store clerk touches and designates the display area 117 corresponding to the commodity placing row (any one of the commodity placing rows 110a to 110e) in which the commodities 103 are sold out. According to the touch and designation, the display area 117 corresponding to a touched and designated coordinate displays the popup menu 122. Subsequently, the store clerk touches and designates the sold-out information display button 124 included in the popup menu 122. According to the touch and designation, the touched and designated display area 117 displays the sold-out information 119 together with the commodity information 118. When the display area 117 on which the sold-out information 119 is displayed is touched and designated, the touched and designated display area 117 displays the popup menu 122. The store clerk touches and designates the normal display button 123 included in the displayed popup menu 122 to stop the display area 117 from displaying the once-displayed sold-out information 119 and display only the commodity information 118.

After causing all the display areas 117, which the store clerk desires to cause to display the sold-out information 119, to display the sold-out information 119, when the store clerk holds the authentication card 115 over the RFID reader 114, the mode of the display 111 changes to the normal mode and the display of the sold-out information 119 is decided. Even if the touch panel 113 is touched after that, the display 111 does not change displayed display content.

In the commodity information display apparatus 101 according to this embodiment, people (e.g., customers) not carrying the authentication card 115 other than store clerks cannot change the mode of the display 111 to the changing mode. Therefore, the people other than the store clerks cannot change the display of the commodity information 118 displayed on the display 111.

In the commodity information display apparatus 101 according to this embodiment, (1) the store clerk touches and designates the touch panel 113 of the display area 117, which the store clerk desires to cause to display the special information 125, to cause the display area 117 to display the popup menu 122 for causing the display area 117 to display the special information 125. Subsequently, (2) the store clerk touches and designates the sold-out information display button 124 from the popup menu 122 displayed on the display area 117, which the store clerk desires to cause to display the special information 125. The store clerk quickly displays the special information 125 only on the display area 117, which the store clerk desires to cause to display the special information 125, simply by performing the touch and designation operation twice as indicated by (1) and (2).

In this embodiment, a ten key may be provided instead of the RFID reader 114. In this case, when the microcomputer 151 determines that an identification number set in advance is input during the mode switching processing (see FIG. 4), the microcomputer 151 changes the mode of the display 111 from the normal mode to the changing mode assuming that authentication is successful. In this embodiment, a switch that the store clerks can turn only with carried keys may be provided instead of the RFID reader 114.

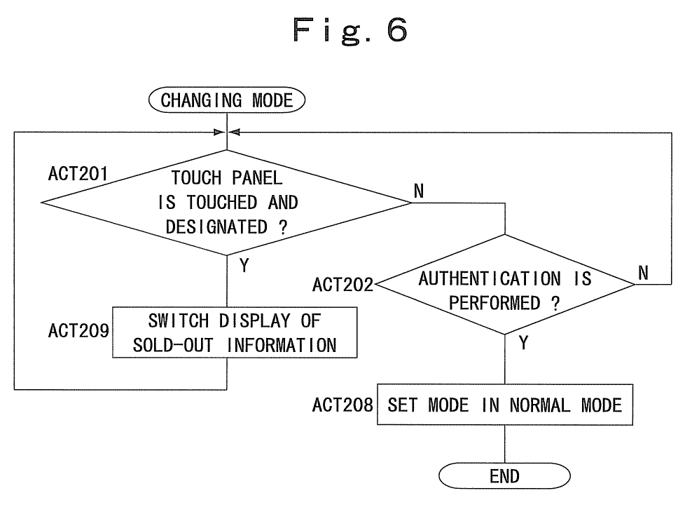

Another embodiment is explained with reference to FIG. 6. In this case, components same as those in the embodiment explained above are denoted by the same reference numerals and signs and explanation of the components is omitted. A commodity information display apparatus according to this embodiment switches display and non-display of the sold-out information 119 when the display area 117 is touched.

FIG. 6 is a flowchart of a flow of display switching processing. In the display switching processing of the commodity information display apparatus 101 according to this embodiment, when the touch panel 113 is touched and designated (Y in Act 201), the microcomputer 151 performs switching processing (Act 209). In the switching processing, when the sold-out information 119 is not displayed on the touched and designated display area 117, the sold-out information 119 is displayed together with the commodity information 118. In the switching processing, when the sold-out information 119 is displayed, the sold-out information 119 disappears and only the commodity information 118 is displayed.

The store clerk can change the display of the commodity information display apparatus 101 more quickly than the display of the commodity information display apparatus 101 according to the embodiment explained above.

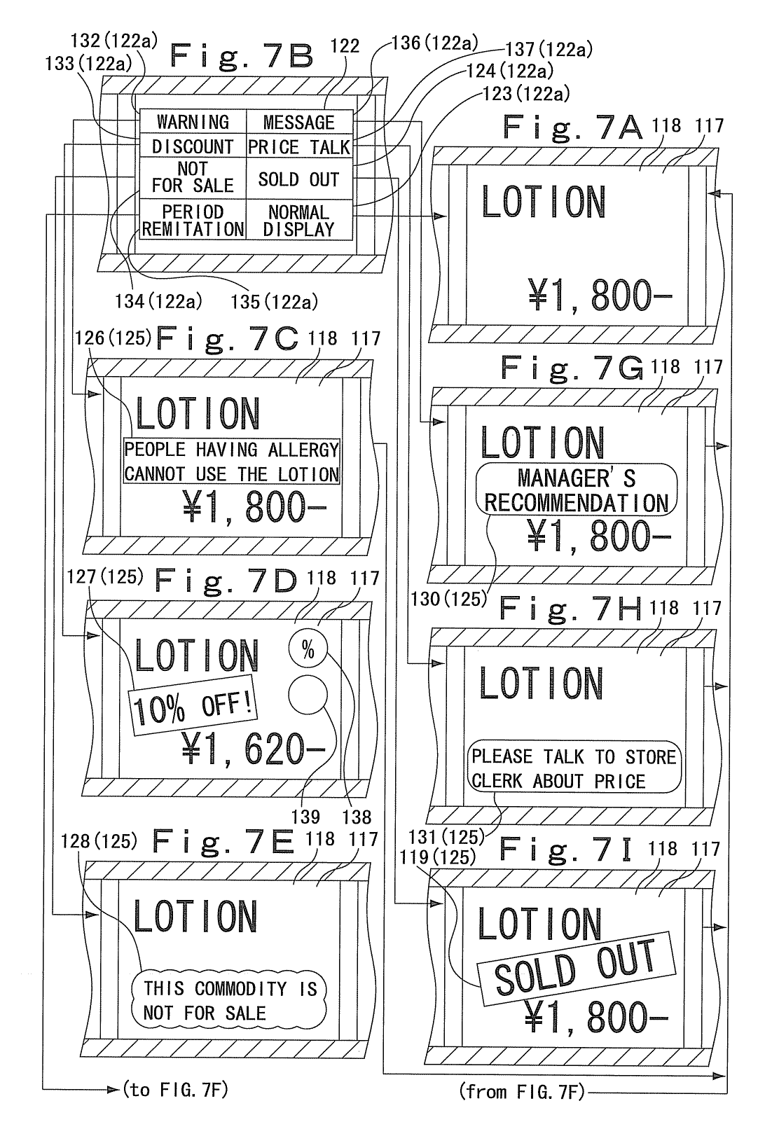

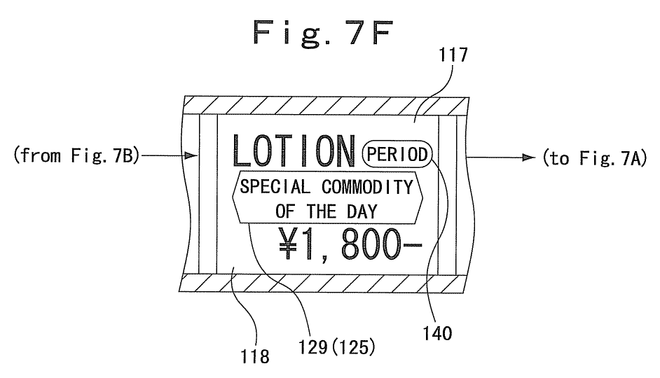

Still another embodiment is explained with reference to FIGS. 7A to 7I. In this case, components same as those in the embodiments explained above are denoted by the same reference numerals and signs and explanation of the components is omitted. In the commodity information display apparatus 101 according to this embodiment, various kinds of special information concerning the commodities 103 displayed in the commodity showcase 102 are switched according to the touch and designation on the display area 117.

FIGS. 7A to 7I are diagrams for explaining a procedure of operation for switching display content of the display 111. The image file F2 according to this embodiment stores various kinds of special information 125 shown in FIGS. 7B to 7I. The special information 125 includes warning information 126, discount information 127, not-for-sale information 128, sales period limitation information 129, message information 130, price talk instruction information 131, and the sold-out information 119. The warning information 126 is an image for urging attention in use of the commodities 103. The discount information 127 is an image indicating that a commodity price is discounted. The not-for-sale information 128 is an image indicating that the commodities 103 are not for sale. The sales period limitation information 129 is an image indicating that a commodity is a sales-period-limited commodity. The message information 130 is an image indicating a message from the store. The price talk instruction information 131 is an image for urging the customer to ask the store clerk about a commodity price.

When the touch panel 113 on the display area 117 on which only the commodity information 118 is displayed is touched and designated, the microcomputer 151 displays the popup menu 122 including the menu buttons 122a on the display area 117. The menu buttons 122a are a warning information display button 132, a discount information button 133, a not-for-sale information button 134, a sales period limitation information button 135, a message information button 136, a price talk instruction information button 137, the sold-out information display button 124, and the normal display button 123. FIGS. 7C to 7I are diagrams of the special information 125 corresponding to the touched and designated menu buttons 122a. The special information 125 is displayed on a front surface of an area in a part of the commodity information 118. For example, when the discount information button 133 is touched and designated, as shown in FIG. 7D, the display area 117 displays the discount information 127, a discount rate setting button 138, and a uniform price setting button 139. When the discount rate setting button 138 is touched and designated, a numerical value of the discount information 127 changes. When the discount information button 133 is touched and designated, the display area 117 displays, instead of the discount information 127, an image (not shown in the figure) indicating that a commodity is sold at a uniform price.

When the sales period limitation information button 135 is touched and designated, as shown in FIG. 7F, the display area 117 displays the sales period limitation information 129 and a period switching button 140. When the period switching button 140 is touched and designated, the display of the sales period limitation information 129 is circularly switched in order of “information concerning a special commodity of the day”, “special commodity of the week”, and “recommended commodity of this month” When the message information button 136 is touched and designated, as shown in FIG. 7G, the display area 117 displays various kinds of message information 130 set in advance.

Obviously, numerous modifications and variations of the present invention are possible in light of the above teachings. It is therefore to be understood that within the scope of the appended claims, the invention may be practiced otherwise than as specifically described herein.

What is claimed is:

1. A commodity information display apparatus comprising:
a display unit that displays commodity information;
an input unit that performs operation input;
an authenticating unit that authenticates authority for changing display content of the display unit; and
an information processing unit that executes:
mode changing processing for setting, only when success of the authentication in the authenticating unit is determined, a mode in a changing mode for permitting a change of the display content displayed on the display unit; and
display changing processing for controlling, in a state in which the mode is set in the changing mode, the display unit according to the operation input from the input unit and performing, on the display unit, any one of normal display for displaying only the commodity information and special display for displaying the commodity information and special information.

2. The apparatus of claim 1, wherein
the display unit includes plural display areas,
the input unit is a touch panel stacked and arranged on a display surface of the display unit, and
in the display changing processing, the information processing unit performs the normal display or the special display on the display area corresponding to a touched and designated coordinate input from the touch panel.

3. The apparatus of claim 2, wherein
the display changing processing includes:
processing for displaying menu items for causing a store clerk to select which of the normal display and the special display should be performed on the display area corresponding to the touched and designated coordinate; and
processing for performing, on the display area, display corresponding to a menu item selected by the touch and designation on the touch panel.

4. A display switching method comprising:
determining whether authentication of authority for changing display content of a display unit, which displays commodity information, is successful;
setting, when the authentication is successful, a mode in a changing mode for permitting a change of the display content displayed on the display unit; and
performing, on the display unit, in a state in which the mode is set in the changing mode, according to operation input from an input unit for performing the operation input, any one of normal display for displaying only the commodity information and special display for displaying the commodity information and special information.
